(19) United States
(12) Patent Application Publication
(10) Pub. No.: US 2004/0158949 A1
(43) Pub. Date: Aug. 19, 2004

(54) Paint and stain applicator kit

(76) Inventors: Wanda Booth, Caro, MI (US); Rosemarie Dumke, Caro, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/775,608

(22) Filed: Feb. 10, 2004

Related U.S. Application Data
(60) Provisional application No. 60/447,182, filed on Feb. 13, 2003.

(51) Int. Cl. B05C 17/00

(52) U.S. Cl. 15/210.1; 15/257.05

(57) ABSTRACT

The invention provides a blade for supporting an applicator pad. The applicator pad includes a plurality of bristles that extend outwardly from the blade. The blade can be flexible to apply coating material to obstructed surfaces. The blade and applicator pad can be part of a kit for applying coating material such as paint or stain to a surface. The kit can also provide a handle for supporting the blade during application of coating materials. An adapter can be connected to the end of the handle to connect a second handle to the first handle and extend the reach of the blade.

### CROSS REFERENCE TO RELATED APPLICATIONS

This application claims the benefit of U.S. Provisional Application No. 60/447,182, for a PAINT AND STAIN APPLICATOR KIT filed on Feb. 13, 2003, which is hereby incorporated by reference in its entirety.

### BACKGROUND OF THE INVENTION

1. Field of the Invention

The invention relates to a kit for applying a coating and, more specifically, the invention provides a paint and stain applicator kit having a blade especially suited for applying paint or stain to obstructed surfaces.

2. Related Prior Art

It can be desirable to apply a coating material to a surface that is difficult to reach. For example, an outdoor deck should be stained or painted to protect wood surfaces from the elements. However, the deck will likely define numerous surfaces that are obstructed, hidden, or only accessible from below. A standard brush can be too wide to fit between obstructions such as deck boards to apply stain or paint to a wood surface. In addition, a brush can accumulate an undesirable quantity of coating material, contributing to undesirable dripping. A brush is also substantially limited to applying coating material to a single surface at a time.

Applicators other than a typical brush have been developed for applying a coating material to a surface. U.S. Pat. No. 4,499,627 provides a coating applicator tool having a pad of fibrous absorbent material disposed on one side of a handle. U.S. Pat. No. 5,560,067 provides a cleaning and polishing device having a pair of cleaning cloths disposed on opposite sides of a gripping portion. However, these alternative brush structures suffer from one or more of the deficiencies of a typical brush described above.

### SUMMARY AND ADVANTAGES OF THE INVENTION

The present invention provides a blade having several faces and an applicator pad attached to the blade and including bristles that extend outwardly from the faces of the blade. The bristles can retain paint or stain for application on a surface. The extension of bristles in several different directions permit the blade and applicator to apply coating to several different surfaces concurrently.

The bristles can be connected to the blade with a substrate that is non-absorbent. Thus, the connection between the bristles and the blade can reduce the likelihood that coating material will accumulate on the blade and contribute to dripping. The blade can be flexible and resilient to bend around obstructions.

The present invention also provides a kit including the inventive blade and applicator pad. The kit can also include a handle extending from the blade that can be gripped by the user during the application of coating material to a surface. An adapter presenting a threaded connection can be connected to the handle. An elongated handle can be engaged with primary handle with the adapter for increasing the reach of the blade. The kit according to the present invention can also include a hook member for bending the blade around an obstruction and a container for containing a quantity of coating material.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of the exemplary embodiment of the kit according to the present invention;

FIG. 2 is a perspective view of the blade and handle shown in FIG. 1;

FIG. 3 is a cross-sectional view of a blade and handle according to the exemplary embodiment of the invention applying coating material to obstructed surfaces such as surfaces defined by an outdoor deck;

FIG. 4 is an exploded view of a handle, an adapter, and a supplementary extended handle according to an embodiment of the invention;

FIG. 5 is a side view of a blade according to an embodiment of the invention being moved across the lip of a container to remove excess coating material;

FIG. 6 is a side view of an alternative embodiment of a blade according to the invention;

FIG. 7 is a side view of the blade shown in FIG. 6 applying coating material to an obstructed surface;

FIG. 8 is a side view of an embodiment of the invention wherein the applicator pad defines a loop and a hook member is provided in the kit to bend the blade around an obstructed surface;

FIG. 9 is a planar view of a blade according to an alternative embodiment of the invention wherein the blade is formed from two different materials;

FIG. 10 is a cross-sectional view of the alternative embodiment of the blade shown in FIG. 9;

FIG. 11 is a side view of the alternative embodiment of the blade shown in FIGS. 9 and 10;

FIG. 12 is a top view of a second alternative embodiment of the invention having a handle portion and a replaceable blade portion; and

FIG. 13 is an exploded view of the second alternative embodiment of the invention shown in FIG. 12.

### DETAILED DESCRIPTION OF THE PREFERRED EMBODIMENT

According to a first aspect in the invention, a first applicator 10 is provided which is adapted particularly for applying stain, water seal, paint, or other coatings to the side edges of deck boards that are secured to cross stringers in closely spaced, gapped relation to one another, and further to the exposed top and side portions of the cross stringers visible through the gap between the deck boards.

This first applicator includes a rigid handle 12 which may be round, rectangular, or other shape and fabricated of wood, plastic, metal or other rigid 10 material. A rigid applicator blade 14 extends from one longitudinal end of the handle 12. The blade 14 preferably has a thickness of about ⅛″ or less and is substantially rigid and inflexible. The blade has a preferred length of about 3¼″, and a width of about 2¼″, although these dimensions can vary depending on the particular application—it being understood that in some cases the particular job may call for a longer or wider applicator or a shorter or narrower applicator blade 14.

The thickness of the blade 14 is preferably less than that of the handle 12. The handle 12 preferably has a thickness no greater than ¼″ to enable the handle 12 to be extended into the gap between adjacent deck boards for accessing the sides of the cross stringers, as will be described below. Most deck boards are applied to the stringers with a gap no less than ¼″, but the invention does contemplate the thickness of the handle 12 being reduced to less than ¼″ if called for by a particular deck application having less than ¼″ board spacing.

The blade 14 presents a front face 16, an opposite back face 18, opposing side faces 20 and an end face 22. The front and back faces 16, 18 are of greater area than that of the side and end faces 20, 22. The front and back faces 16, 18 are preferably planar and parallel to one another, as are the side faces 20. The end face 22 is preferably formed at right angles to the front and back faces 16, 18 and the side faces 20.

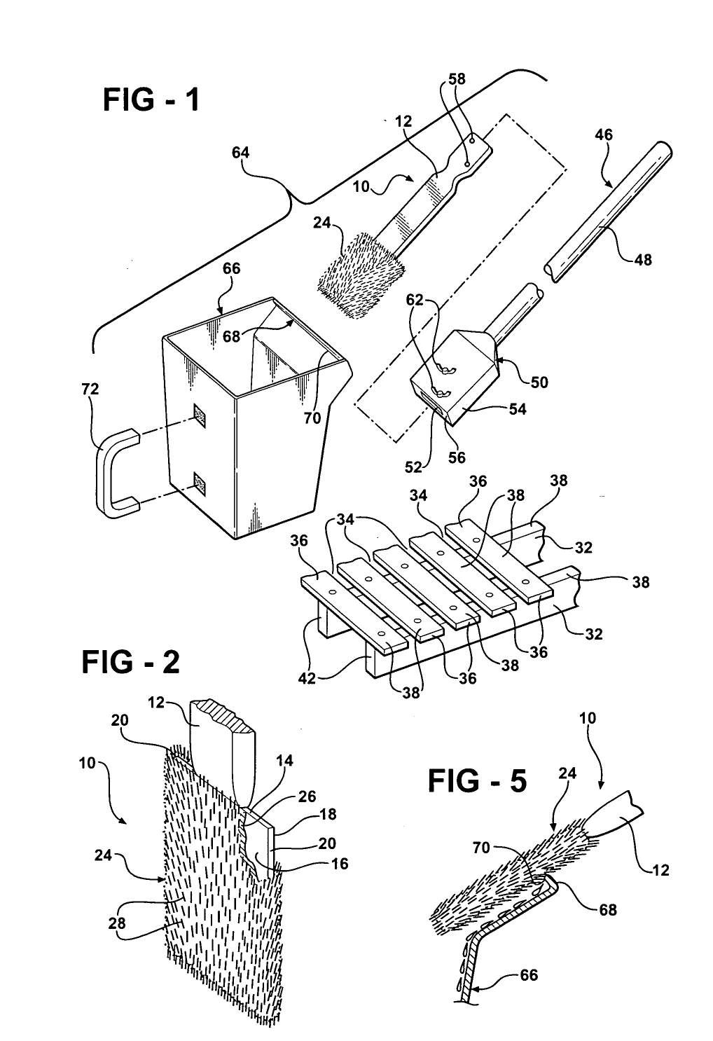

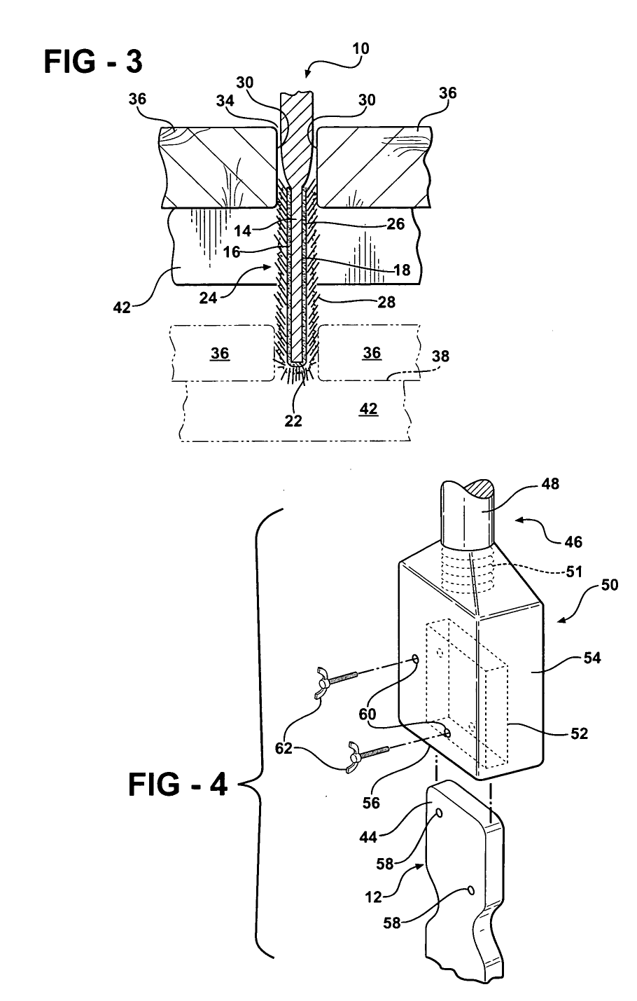

An applicator pad 24 is secured to the blade 14 and is applied to each of the front 16, back 18, side 20 and end 22 faces of the blade. The pad 24 preferably has a fabric backing or substrate 26 which is glued or otherwise adhered to the rigid blade so as to completely cover its surfaces. A pile of bristles 28 extends outwardly from the fabric backing 26. The bristles 28 are preferably directional and, as shown in FIGS. 1, 3 and 5, project outwardly from the front and back faces 16, 18 across the entire face and are also angled upwardly toward the handle 12. The bristles 28 likewise extend outwardly and upwardly from the side faces 20 of the blade. The bristles 28 extend outwardly and downwardly from the end face 22 away from the handle 12. It has been found that the upward inclination of the bristles 28 on the front and back faces 16, 18 as well as the side faces 20 helps hold stain from dripping off the pad 24 and provides a more efficient, uniform application of stain to side edges 30 of the deck boards as well as the side faces 32 of the stringers 42, as illustrated in FIG. 3. Still referring to FIG. 3, as the blade 14 is extended into the gap 34 between adjacent deck boards 36, the stain-soaked bristles 28 contact and apply stain to the edges 30 and, as the blade 14 is withdrawn upwardly, the upwardly angled bristles collect any excess stain so as not to leave any drips or heavy regions of stain on the edges 30 for uniform, drip-free application of the stain. The upwardly directed bristles also enable the user to apply stain in the longitudinal or lengthwise direction of the edges 30 by angling the handle 12 and pulling the blade 14 against the direction of the bristles 28, or by simply moving the blade 14 generally sideways and drawing the blade 14 upwardly as required to remove any drips or excess stain.

As illustrated best in FIG. 3, the thickness of the pad 24 is equal to or slightly greater than the standard ¼″ gap 34 between adjacent side edges 30 of the boards 36 so that stain is applied to both of the opposing side edges 30 when the blade 14 is extended between the deck boards 30. In a preferred embodiment, the thickness of the pad 24 is approximately 1/4″ or slightly greater for use with deck boards 36 having a standard ¼″ gap 34 between the side edges 30 of the boards.

As also illustrated in FIG. 3 in broken chain line view, the bristles 28 projecting from the end face 22 of the blade 14 enable the exposed top surface 38 of the supportive stringers 42 to be stained as well as the same time the side edges 30 are stained. This enables the user to apply a uniform, drip-free application of stain to all exposed edge and top surfaces of the deck boards 30 and stringers 42 residing below the top surface 42 of the deck boards 36.

Preferably, the pad 24 is free of any foam which would hold excessive amounts of stain and lead to dripping and which would be prone to snagging or tearing when drawn across the side edges 30 of the deck boards 36. The pad-covered blade 14 thus presents a solid, rigid core which is substantially inflexible and covered by a soft pile of the directional bristles 28 on all of its faces 16, 18, 20 and 22 to provide a long lasting, durable applicator for efficient, drip-free application of stain to the side edges 30 of the deck boards 36 and the side and top surfaces 32, 38 of the portions of the stringers 42 visible through the gap 34.

According to a further aspect of the invention as illustrated in FIGS. 1 and 4, the applicator handle 12 is preferably connectable at its upper end 44 to an extension handle 46. The extension handle 46 preferably includes an elongate pole or rod 48 which is preferably several feet in length (e.g., 3-6 feet) and is provided with a coupling 50 at its lower end for releasably securing the upper end 44 of the applicator handle 12 to the pole 48 in a manner that enables the user to use the applicator as described above while standing in an upright position.

While the invention contemplates any of a number of ways of securing the applicator handle 12 rigidly but releasably to the pole 48 through various coupling configurations 50, the one illustrated in FIG. 4 is in the form of a blind socket 52 formed in an enlarged coupling head 54 at the base of the pole 48 and open to its bottom surface 56. The pole 48 is preferably removable secured to the coupling 50 by a threaded end 51 of the pole 48 received in a threaded bore of the coupling, as illustrated in FIG. 4. The socket 52 is sized to receive the handle 12 snugly into the socket 52. The applicator handle 12 is preferably formed with a pair of offset openings 58 at the upper end 44 which align with associated openings 60 in the coupling head 54 in which a pair of thumbscrews 62, or the like, are received for releasably securing the applicator handle 12 rigidly and immovably within the socket 52 such that the pole 48 provides a rigid extension of the applicator handle 12.

According to a further aspect of the invention, the applicator 10 forms one component of an overall stain or paint kit 64 which includes a special container 66, illustrated in FIGS. 1 and 5, designed to work with the applicator 10. The container 66 has a planar edge 68 defining a planar wiping lip 70 that is rolled inwardly toward the container 66. As illustrated in FIG. 5, after the blade 14 has been dipped into the stain within the container 66, any excess can be removed by drawing the front and back faces 16, 18 against the planar wiping lip 70, causing any excess to drip off the blade 14 and off the lip 70 back into the container.

The container 66 is preferably stackable in nested fashion with other like containers so that several of the containers can be steadied and displayed for retail sale. The container 66 preferably includes a handle 72 that is removably connected to the container 66 in order to retain the stackability of the containers. Alternatively, recessed handholds could be formed in the wall of the container for grasping by the user while retaining the stackability of the container 66 with other like containers.

The extension handle 46 may also comprise part of the kit 64.

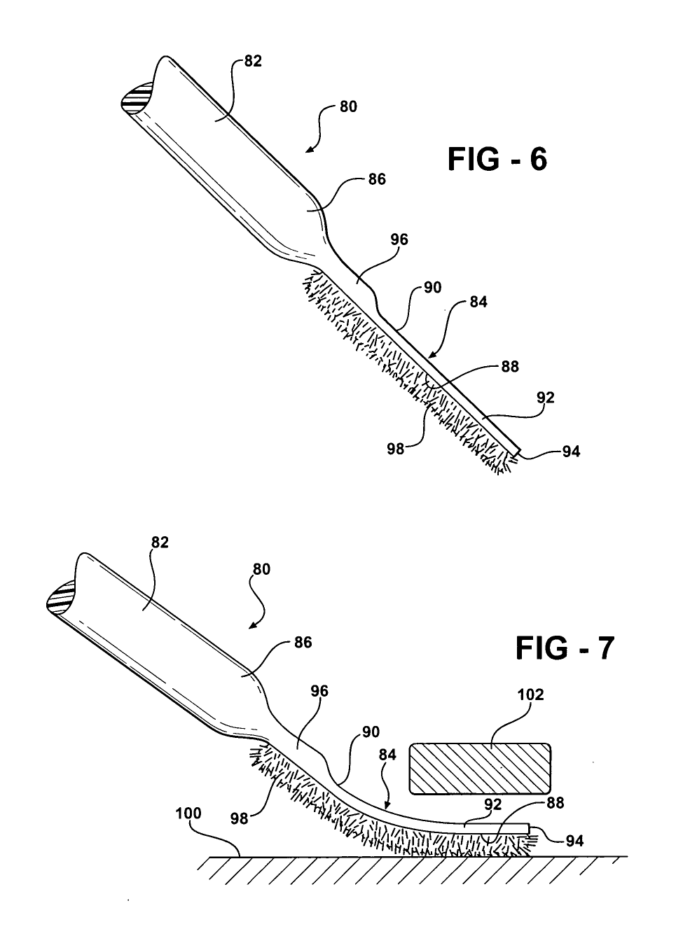

FIGS. 6 and 7 illustrate another aspect of the invention. The illustrated applicator 80 includes a rigid handle 82 which may be of any desired shape, such as round, flat, contoured, or the like. A blade 84 extends from a lower end 86 of the handle and is preferably, but not necessarily, formed of the same material as that as the handle 82. The blade 84 and handle 82 are preferably molded of the same plastics material which renders the blade 84 considerably more flexible than that of the handle 82. Preferably, the handle 82 is constructed with a shape and size that renders it relatively rigid, while the blade 84 is elastically flexible as described in greater detail below.

The blade 84 has a substantially planar applicator face 88 and a back face 90. The blade 84 has a main body portion 92 which is preferably of uniform thickness of about ⅛″ or less extending from the distal end 94 of the blade 84 back toward the handle 82 and transitions into a reinforced thickened portion 96 adjacent the lower end 86 of the handle 82. In this manner, the blade 84 is highly flexible along the main body portion 92, and relatively less flexible in the region of the thickened portion 96 backing the applicator face 88, and transitioning into the handle 82 which is considerably more rigid than either the main body portion 92 or thickened portion 96. The thickened portion 96 preferably has a thickness of about twice that of the main body portion 92, but may be proportionally thicker or thinner if desired. The thickened portion 96 provides a relatively rigid reinforcement backing to a portion of the blade 84 while preserving an unencumbered applicator face 88. Further, the thickened portion 96 can be made so as to be substantially rigid and inflexible while the main body portion 92 remains flexible by selection of material or thickness.

An applicator pad 98 is adhered to the applicator face 88 of the blade 84 and may comprise any of a number of materials, such as fabric-backed directional bristles as described with the first embodiment, a synthetic nap of fibrous material similar to that used on paint roller heads which may be of any desired thickness, etc., with the provision that the applicator pad 98 be flexible so as not to impair the flexibility of the main body portion 92. The back face 90 of the blade 84 is free of any applicator pad 98. The applicator pad 98 may be secured to the applicator face 88 by any suitable means, such as adhesives, heat bonding, etc.

At least the main body portion 92 of the applicator 80 is preferably fabricated of PET-G, polyethylene terephalate-glycol. This material is preferred as it has the properties of being elastically flexible enabling the main body portion 92 to be bent as illustrated in FIG. 7 under application of a bending force by the user and then to return to a straight condition as in FIG. 6 when the force is removed. This ability to bend enables the blade 84 to be extended into tight areas that are inaccessible by a conventional paintbrush, such as painting a surface 100 behind an obstruction 102, as illustrated in FIG. 7. Other uses include painting the slats of a fence, the surfaces of louvered window shades, behind poles and wires, and like applications, where paint is applied by the applicator pad 98 to the desired surface, while the back face 90 is free of any paint or applicator in order to prevent paint from being applied to the adjacent surface of the obstructing piece 102.

The preferred PET-G material has some additional properties which are highly preferable for use with the applicator 80. This material has the beneficial property of a high surface tension which causes the material to reject paint, stains and other fluids from sticking or coating on the exposed surface. In this way, even if the blade 84 is dipped into paint, the exposed back face 90 sheds the paint or stain and is substantially clean and free of paint or stain once removed and in use. The PET-G material has the additional advantageous property of being bendable without breaking. The main body portion 92 made of this material can be bent 90 degrees or even 180 degrees back upon itself and the blade will not break. As such, the blade is highly durable. The PET-G material has the further advantageous property of being plastically deformable and malleable if the material is creased, enabling the user to bend the main body portion 92 to a predetermined angle where it will remain in place after the bending force is removed, and then allow the user to bend the blade straight again or to a different angle repeatedly without breaking. The applicator 80 can be used as part of the kit of FIG. 1 in addition to or in lieu of the applicator 10.

The blade 14 or blade 84 can be formed from a sheet of Vivak®. Preferably, the blade 14 or 84 is made from a material offering superior impact strength over acrylic material and cost effectiveness compared to polycarbonate material. In addition, the blade 14 or 84 is preferably formed from material that can be bonded or fastened with adhesives, ultrasonic welding or rivets.

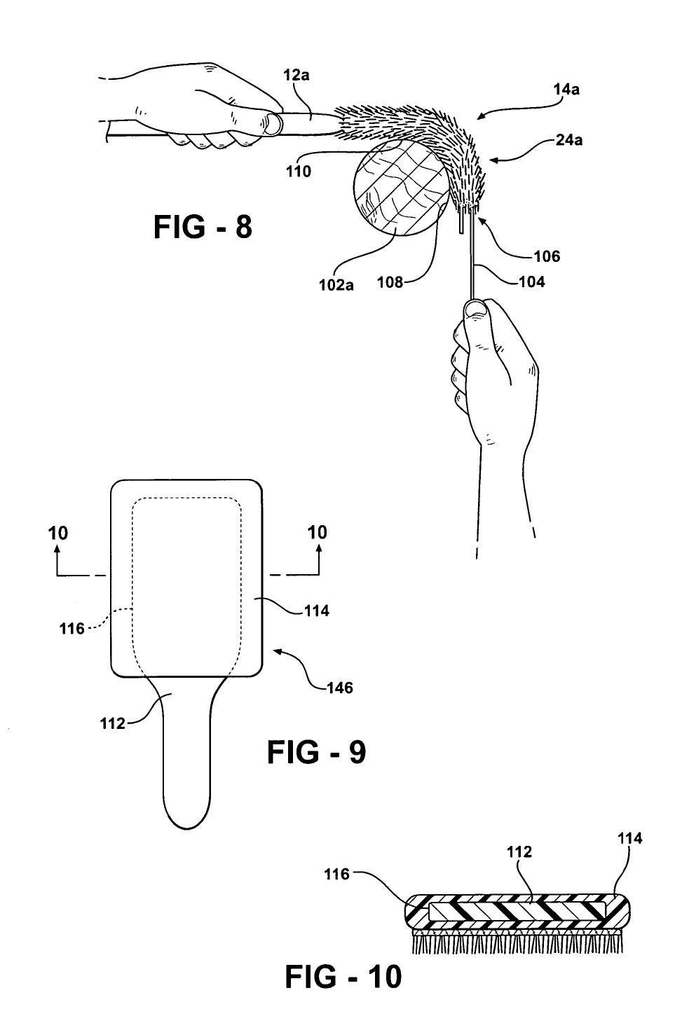

Referring now to FIG. 8, in an alternative embodiment of the invention, the kit includes a hook member 104. The hook member 104 can engage a loop 106 defined by one of the blade 14a and the applicator pad 24a. In the exemplary embodiment of the invention shown in FIG. 8, the loop 106 is defined by the applicator pad 24a. A user of the blade 14a can grasp the handle 12a with one hand and insert an end of the hook member 104 in the loop 106 with the other hand. The blade 14a can be flexible to bend around the obstruction 102a to apply coating material to surfaces 108 and 110. The blade 14a can be flexible and resilient, returning to a desired shape after being bent.

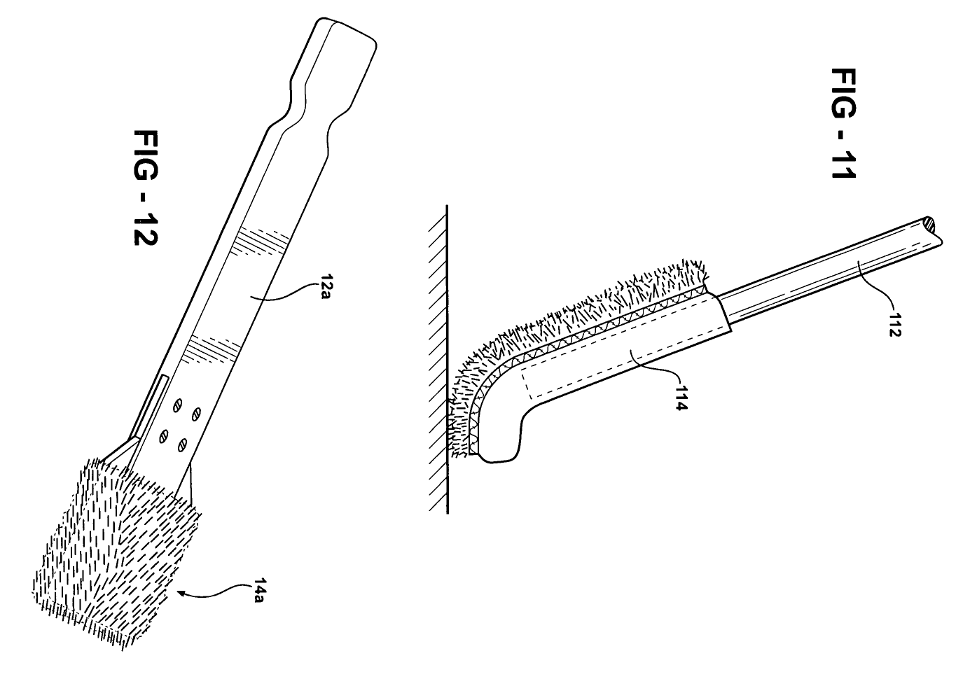

Referring now to FIG. 9, in an alternate embodiment of the invention, the blade 14b is formed from two different materials. The blade 14b includes a first planar member 112 and a second planar member 114. The first planar member 112 defines an edge 116. The second planar member 114 extends from the edge 116. As shown in FIG. 10, the second planar member 114 surrounds the first planar member 112. The first planar member 112 can be formed from a relatively more rigid material than the second planar member 114. For example, the first planar member 112 can be formed from polyethylene terephalate-glycol, and the second planar member 114 can be formed from silicone. The relatively less rigid second planar member 114 can be desirable to enhance the coating of material in obstructed corners. FIG. 11 shows the planar member 114 being more flexible than the planar member 112.

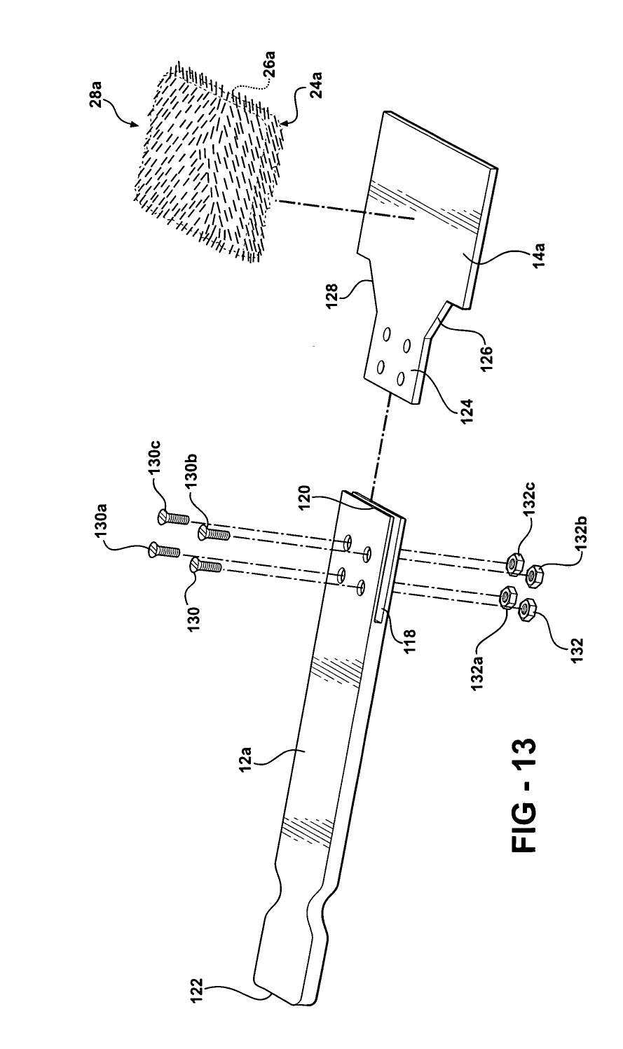

FIGS. 12 and 13 show a second alternative embodiment of the invention. The embodiment of the invention includes a handle 12a defining a slot 118. By way of example and not limitation, the handle 12a is approximately ten to eleven inches long, one and one-eight inches in width, and one-quarter inch thick. The slot 118 extends from one end 120 of the handle 12a approximately four and three-quarters inches toward a second end 122 of the handle 12a.

The slot 118 engages a blade 14a. The blade 14a includes a portion 124 insertable in the slot 118. A pair of gussets 126, 128 are disposed on opposite sides of the portion 124 to reduce the likelihood of cracking of the blade 14a during use. By way of example and not limitation, the blade 14a has a length of four and one-half inches, a width of two and seven-eighths inches, and a thickness of one-eighth inch. A applicator pad 24a having a fabric substrate 26a with bristles 28a is glued to the blade 14a. An applicator pad is glued to each outwardly facing surface of the blade 14a except the portion 124. Alternatively, a single applicator pad can be glued to only one surface of the blade 14a or more than one, but less than all surfaces of the blade 14a can receive an applicator pad. The handle 12a and blade 14a can be connected to one another with a plurality of fasteners such as set screws 130, 130a, 130b, 130c and nuts 132, 132a, 132b, 132c.

In operation, the handle 12a can be used several times with a kit of several blades, each blade being receivable in the slot 118. Individual blades can be designed for specific uses such as slats of a fence, louvered windows and shutters, picnic tables, T111 siding, and Adirondack chairs. For example, the width of the blade can correspond to the size of the channel formed in T111 siding.

It is to be understood that other embodiments of the invention which accomplish the same function are incorporated herein within the scope of any ultimately allowed patent claims. Also, while the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for applying a coating such as one of paint and stain comprising:
a blade having a front face and a back face interconnected and surrounded by an edge surface, said edge surface including a handle-end edge surface and a leading-end edge surface and side edge surfaces interconnecting said end edge surfaces; and
an applicator pad including a plurality of bristles extending outwardly from said faces and said side edge surfaces and said leading-end edge surface.

2. The apparatus of claim 1 wherein said bristles are directional.

3. The apparatus of claim 1 wherein said bristles adjacent said front and back faces and adjacent said side edge surfaces being slanted toward said handle-end surface.

4. The apparatus of claim 3 wherein said bristles adjacent said leading-end edge surface extend away from said handle-end surface.

5. The apparatus of claim 1 wherein said blade is resilient.

6. The apparatus of claim 1 wherein said blade is formed from at least two different materials.

7. The apparatus of claim 6 wherein said blade includes a first planar member defining an edge and being formed from a first material and a second planar member extending from said edge of said first planar member and defining said first and second side faces and said side edge surfaces wherein said second planar member being formed from a second material and said second material being more elastic than said first material.

8. The apparatus of claim 1 wherein said applicator pad includes a non-absorbent fabric backing fixedly associated with said blade.

9. The apparatus of claim 1 wherein a thickness of said blade increases between said leading-end edge surface and said handle-end surface.

10. The apparatus of claim 1 wherein a rigidity of said blade increases between said leading-end edge surface and said handle-end surface.

11. The apparatus of claim 1 wherein a rigidity of said blade changes between said side edge surfaces.

12. An apparatus for applying a coating such as one of paint and stain comprising:
a blade having a front face and a back face interconnected and surrounded by an edge surface, said edge surface including a handle-end edge surface and a leading-end edge surface and side edge surfaces interconnecting said end edge surfaces;
a handle for extending from said handle-end edge surface to a distal end;
an adapter for connection to said distal end of said handle and presenting a threaded connector; and
an applicator pad including a plurality of bristles for extending outwardly from said faces and said edge surfaces and said leading-end edge surface.

13. The apparatus of claim 12 wherein a thickness of said blade is less than a thickness of said handle.

14. The apparatus of claim 12 wherein said blade is one of releasibly connected to and integral with said handle.

15. The apparatus of claim 12 wherein one of said blade and said applicator pad includes a loop portion and said apparatus includes a hook member insertable in said loop portion to bend said blade and said applicator pad.

16. The apparatus of claim 1 including a container defining an inwardly angled wiping lip and a handle releasibly engageable with said container.

17. The apparatus of claim 12 wherein said blade is formed, at least in part, from polyethylene terephalate-glycol.

18. The apparatus of claim 12 including a plurality of differently sized blades and corresponding applicator pads wherein each of said blades is releasibly connected to said handle.

19. An apparatus for applying a coating such as one of paint and stain comprising:
a resilient blade having a front face and a back face interconnected and surrounded by and edge surface, said edge surface including a handle-end edge surface and a leading-end edge surface and side edge surfaces interconnecting said end edge surfaces;
a handle for extending from said handle-end edge surface to a distal end;
an adapter for connection to said distal end of said handle and presenting a threaded connector;
an applicator pad including a plurality of bristles for extending outwardly from said faces and said edge surfaces and said leading-end edge surface and said applicator pad including a loop portion;
a hook member insertable in said loop portion to bend said blade and said applicator pad;
a container defining an inwardly angled wiping lip; and
a handle releasibly engageable with said container.

20. An apparatus for applying a coating such as one of paint and stain comprising:
a blade having a front face and a back face interconnected and surrounded by an edge surface, said edge surface including a handle-end edge surface and a leading-end edge surface and side edge surfaces interconnecting said end edge surfaces;
an applicator pad including a plurality of bristles extending outwardly from one of said faces; and
a handle extending from said handle-end edge surface and integrally formed with said blade wherein said handle is thicker than said blade.
